(19) United States
(12) Patent Application Publication
(10) Pub. No.: US 2017/0372262 A1
(43) Pub. Date: Dec. 28, 2017

(54) System and Method for In-Transit Cargo Monitoring Utilizing Sensor Device and Telematics

(71) Applicant: Robert Ray Haney, Elk Grove, CA (US)

(72) Inventor: Robert Ray Haney, Elk Grove, CA (US)

(21) Appl. No.: 15/633,371

(22) Filed: Jun. 26, 2017

Related U.S. Application Data
(60) Provisional application No. 62/355,685, filed on Jun. 28, 2016.

(51) Int. Cl. G06Q 10/08; G06Q 50/28

(52) U.S. Cl. CPC G06Q 10/0833; G06Q 50/28

(57) ABSTRACT

A method and system enables a transporter of cargo to receive real-time status data from an active “tag” device with a sensor affixed to the cargo by connecting the tag device with a mobile application, or “app,” downloaded on a delivery driver's smart phone. The sensor data from the device combines with the geo-location data available on the delivery driver phone to provide the originator with real time status of his cargo and exact geo-location during transit from warehouse to delivery destination.

### CROSS REFERENCE TO RELATED APPLICATIONS

This application claims priority to U.S. application Ser. No 62/355,865, filed on Jun. 28, 2016, which is incorporated herein in its entirety.

### FIELD OF THE INVENTION

The embodiments herein relate to monitoring devices and systems and methods relating thereto. In particular, although not exclusively, the invention is related to monitoring devices for remotely monitoring location of a cargo as well as monitoring the conditions to which a cargo is exposed along a route.

### BACKGROUND OF THE INVENTION

Accordingly, there has until the present invention, existed a need for commercially useful systems exhibiting both sensor properties yet being low cost and not requiring a GPS to be built into the chip.

There are currently various solutions for monitoring, tracking and identifying cargo or objects. These solutions may include monitoring devices that monitor a condition and communicate sensor module data to a remote server computer.

Shipping of product, for example, by truck delivery, is generally contracted by the person wishing to have the goods delivered (e.g. the shipper) with a business or individual who provides truck delivery services (e.g. the transporter) either directly or through an intermediary. Once contracted, the shipper must wait for status information and delivery confirmation to be returned from the transporter. In most cases, cargo status is unknown by the shipper until a confirmation that the cargo has been delivered to the destination is sent from the transporter to the shipper. The status of the shipment during transit is generally unknown to the shipper. This is true for inexpensive and common goods, e.g. dry goods, and also for high value or temperature-sensitive goods.

In some cases, the transporter may have deployed a GPS tracking device to monitor the status of the transport vehicle, e.g. truck. These devices are useful to provide location information related to the truck. However, the GPS system does not provide data that is specific to the shipper's cargo and the shipper generally does not have access to the GPS data from the transporter.

Recently tracking devices with integrated sensors called “tags” have become available to provide the shipper with a new option for monitoring status of cargo in transit. A shipper can apply a “tag” to the cargo and then receive updated status information from the tag's sensor array which describes the status of the cargo in transit.

Typically, a cargo tracking “tag” will offer sensors for conditions such as temperature, humidity, acceleration and light. The tag device also collects location information via GPS or by GSM methods and then transmits location and sensor data via mobile networks. The “tag” applied to cargo represents a good option for high-end freight. However, the cost of a tag device with an integrated GPS or GMS location and mobile network transmission capability can be quite high and therefore becomes impractical for most common cargo. Additionally, the power requirements can be quite hefty requiring a robust power source.

If products arrive damaged or incomplete, a seller's customers may blame the company and the brand, resulting in reduced sales and negative reviews. Thus, there is a need for a low-cost, simple system and method for tracking goods to control consistent quality products built and packed by makers who also need to monitor the transport and delivery. Such systems and methods should be simple and leverage existing networks without requiring installing and maintenance of unnecessary or complicated components. Such a system would deliver real-time monitoring of goods in transit to the shipper thereby ensuring product quality and/or security and provide protection against the loss of the cargo and also protect the brand by preventing delivery of damaged products to the end customer.

### SUMMARY OF THE INVENTION

The present embodiments teach, in one instance, a system for assessing cargo conditions. The cargo can occupy a cargo area on a transport vehicle. The system comprises at least one tag device wherein each tag device comprises at least one sensor operative to determine at least one data point indicative of conditions of the cargo, a device associated with a driver of the vessel, the device having access to a communications network, and an app installed on the device configured to determine a geo-location of the device. In one embodiment, a mobile function is integrated into the device associated with the driver and not integrated into the at least one tag. In one embodiment, the at least one data point is available in real time. In one embodiment, the geo-location is available in real time.

The data from the at least one sensor retrieved by the device is combined with the geo-location data available on the device to provide a shipper with real time status of the cargo and exact geo-location during transit from a source to a destination. The data is stored in a location that is not in the monitoring device. In one embodiment, the monitoring device comprises a memory. In one embodiment, certain data is stored on a driver's mobile device.

In one embodiment of the system, the at least one tag has connectivity with the device via a bluetooth connection. The at least one sensor associated with the at least one tag can collect and transmit data associated with an air temperature of the inside of the vessel. The at least one sensor associated with the at least one tag is collecting and transmitting data associated with a temperature of the cargo itself, inside of the vessel. In an embodiment, the at least one sensor associated with the at least one tag is collecting and transmitting data associated with an indication of stability of the cargo. In an embodiment, the at least one sensor associated with the at least one tag is collecting and transmitting data associated with an indication of light conditions inside the cargo area of the vessel. In an embodiment, the least one sensor associated with the at least one tag is collecting and transmitting data associated with an indication of a humidity level of the cargo area associated with the vessel.

One embodiment comprises a method for assessing cargo conditions, said cargo being located on a transport vehicle. The method steps comprise, positioning a tag comprising a sensor on or near the cargo, establishing a connection between a device associated with a driver of the transport vehicle and the tag, communicating with a control tower via an app on the device associated with the driver, and receiving, in the device associated with the driver, data from sensor associated with the tag positioned on the cargo, receiving, in the device, telematic data from the mobile device, combining sensor data with telematics data, and delivering cargo conditions data and telematic information to a shipper.

In an embodiment, the establishing a connection comprises the sensor transmitting a unique identification code together with status from the sensor. In an embodiment, another step comprises connecting with the device to actively seek a connection with the tag device using a mobile device sensing protocol. In an embodiment, the method further comprises connecting the tag to the driver device wherein the app on the device is configured to receive data from the tag sensors and combine this data with telematics from the mobile phone including the GPS position of the delivery driver. The sensor data from the tag device and telematics data from the mobile phone GPS system is the cargo status that informs the shipper as to the state condition and location of cargo during the delivery process. The data is updated via the mobile app to the system through existing mobile networks and is thereby available to the shipper on demand. The telematic data comprises geo-location data.

### BRIEF DESCRIPTION OF THE DRAWINGS

The foregoing summary, as well as the following detailed description of the invention, will be better understood when read in conjunction with the appended drawings. It should be understood, however, that the invention is not limited to the precise arrangements and instrumentalities shown herein. Conceptual diagram of the data flow “method” and interaction of the users with the technology “system” is provided for the purpose of illustrating example embodiments.

FIG. 1A is an example embodiment of a conceptual diagram of the data flow describing the system.

FIG. 1B is an example embodiment of an exemplary system schematic.

FIG. 2 is an example embodiment of a control tower.

FIG. 3 shows an example embodiment of a conceptual diagram of the data flow describing the method.

FIG. 4A shows an example embodiment of a screenshot showing how the control tower can be extended to allow for delivery driver assignment to a specific shipment.

FIG. 4B shows an example embodiment of a screenshot showing data related to a transport operator, or driver.

The invention is not limited to the structures illustrated. Various embodiments and alternative methods are envisioned although not illustrated. The drawings are not to scale and in no way are intended to limit the scope of the invention.

### DETAILED DESCRIPTION

An example embodiment relates to cargo delivery services and applies to all aspects of delivery, for example, from complete truck loads to small deliveries and parcel deliveries. In other embodiments, other methods of delivery are utilized.

In the following sections, detailed descriptions of examples and methods of the disclosure are given. The description of both preferred and alternative examples are exemplary only, and it is understood that to those individuals and teams skilled in the arts, that variations, modifications, and alterations may be apparent. It is therefore to be understood that the examples do not limit the broadness of the aspects of the underlying disclosure as defined by the claims.

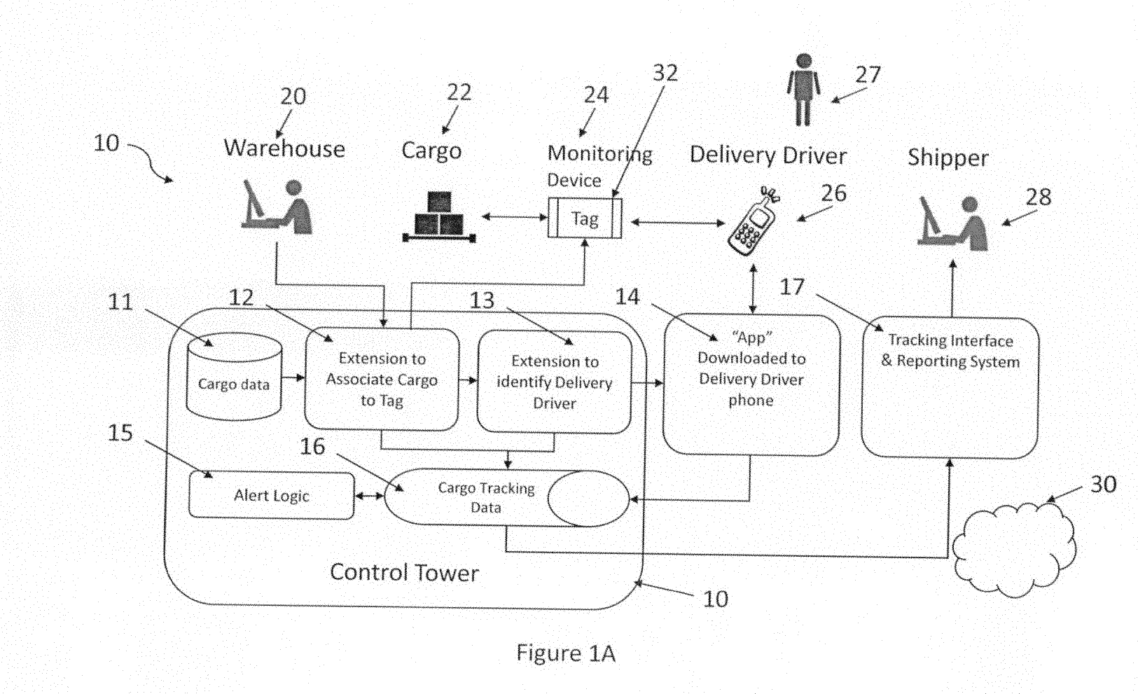

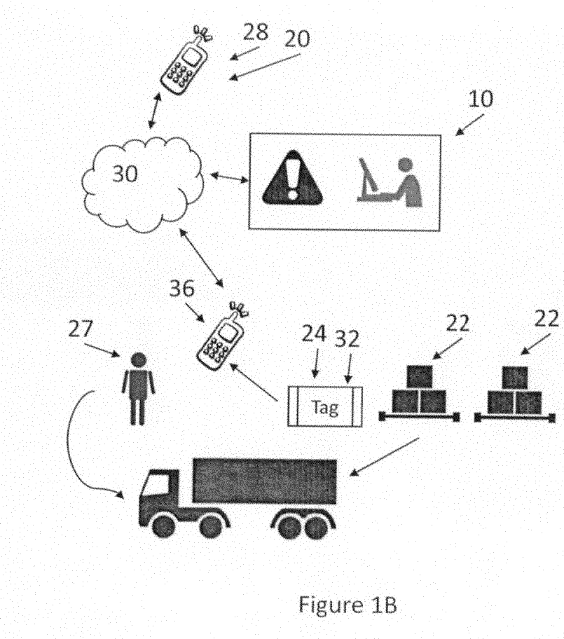

FIG. 1A is a schematic diagram which illustrates a system 100 according to one embodiment. System 100 comprises a warehouse 20, cargo 22, a monitoring device, or tag 24 comprising a sensor 32, a device 26 associated to a delivery person, e.g. a driver, 27, a shipper 28, an app 14, tracking interface 17, communication network 30, and control tower (including an Internet of Things or IoT platform) 10.

FIG. 1B is a schematic diagram illustrating and exemplary system.

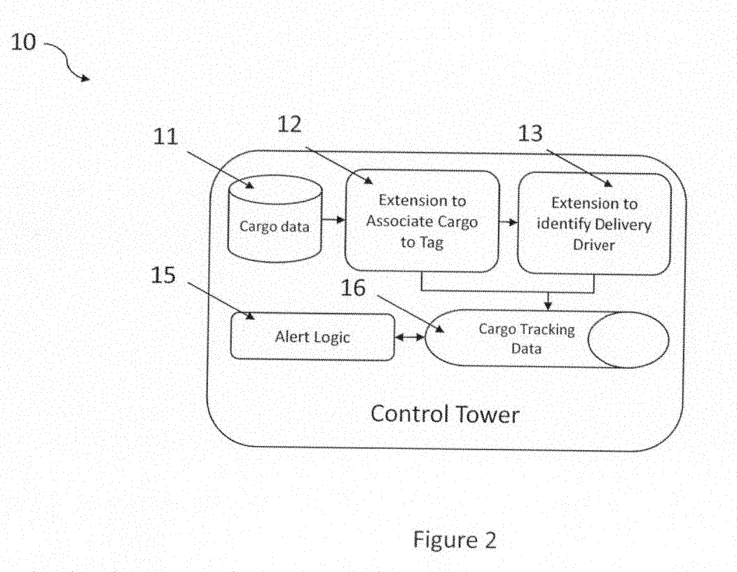

FIG. 2 is a schematic diagram of the control tower 10, assessable via the device 26 and receives data into the mobile app 14, the data being generated by at least one sensor 32 for the purposes of monitoring the cargo. The control tower 10 comprises cargo data 11, extension to associate cargo to tag 12, extension to identify delivery driver 13, alert logic 15, and cargo tracking data 16.

Referring now to FIG. 1A, FIG. 1B, and FIG. 2, each monitoring device, or tag 24 is configured to monitor one or more conditions, for example, using a sensor which produces sensor data related to the one or conditions.

A user, e.g. 20 or 28, may be any user of the system 100. For example, users may include persons receiving the cargo, persons sending the cargo, persons responsible for the transport and integrity of the cargo, and persons monitoring the cargo conditions. In one embodiment, users may be able to perform various different functions and view different data according to whatever capacity they are currently working. References to a user within this written description are mean to include any user as defined or inferred by this paragraph.

A tag is a device whose purpose is to collect data via one or an array of sensors and integrated data communications. Each tag comprises a sensor. In one embodiment, a tag comprises more than one sensor. Types of sensors include, but are not limited to, infrared and ambient temperature, ambient light, humidity, barometric pressure, motion tracking, (e.g. gyroscope, accelerometer, and compass) and a magnet. The conditions that the tags are monitoring within a cargo area are usually environmental or physical conditions associated with the cargo area environment in which the tag 24 finds itself. The conditions may, for example, be rotation, gravity acceleration, vibration, temperature, barometric pressure, humidity, magnetic field, luminous intensity, sound, radiation, and a measure of time. The vision of system 100 can be associated with a single concept, the internet of things (IoT), where through the use of sensors integrated with tags, the entire physical infrastructure is closely coupled with information and communication technologies.

Each tag 24 is configured to transmit sensor data to a mobile app. Each tag has a Media Access Control (MAC) code to associate it in the firmware. The sensor and the mobile app are paired using the MAC code. The mobile app is usually set remotely (via the control tower or using another data integration utility) to pair with the sensor using the MAC code so when the driver is within range, they pair automatically. In another embodiment the MAC code can be written on the tag and entered into the app manually by the user. In some embodiments, the tag 24 may be configured to monitor, transmit the environmental and physical status of a cargo object with which it is associated. In some embodiments, the tag 24 is purposely built to maintain data internally for short intervals if the mobile app is temporarily disconnected from the sensor. In this scenario, the tag will record the sensor data locally and then when the mobile app is reconnected, transmit all recorded data. The monitoring device or tag 24 may further include a sensor 32 which monitors a condition to which the object is exposed and produces or outputs sensor data relating to the condition. The sensor 32 may include one or more of: an angular rate sensor such as a gyroscope; an accelerometer; a gravitational sensor; a temperature sensor; a barometer and a luxometer or light sensor. Accordingly, the sensor may monitor conditions including one or more of: rotation, acceleration, vibration, temperature, barometric pressure, humidity, magnetic sensor; a magnetometer; a digital luminosity sensor; a clock; and the field, luminous intensity, and a measure of time to which the product associated with the sensor 32 is exposed. The sensor data output by the sensor 32 may therefore include actual measurements and/or estimates of a condition. In one embodiment, the data produced by the sensor 32 is raw data which requires processing.

Table 1 shows example sensor tags that could be used in a normal deployment. Internet of Things (IoT) sensor hardware are commercially available. In a preferred embodiment, the sensor firmware is customized to maximize battery life by disabling un-needed sensor activity and by regulating the frequency of data transmission. In another embodiment, a customer may require customized hardware to specific sensor capability or to provide additional storage of data while if the sensor is temporarily disconnected from the mobile app.

In one embodiment, the tag 24 is attached to objects in the cargo. In other embodiments, the tag 24 is embedded in or on, or fastened to or otherwise closely associated with the objects in the cargo 22 by being affixed to the inside of the cargo hold of a transport vehicle, for example, a truck. Cargo or cargo objects can include the cargo itself, or it can include other objects in the cargo hold area. Cargo 22 may include, but are not limited to, boxes, crates, containers, pallets, etc for the transportation of goods, perishable goods, cold goods, consumer goods, goods such as pharmaceuticals, fruit, flowers, frozen goods, and the like.

In the embodiment illustrated in FIG. 1, a device 26 is associated with a truck, a driver 27, or some other transport vehicle. A mobile communications network 30 is associated with the device 26. In one embodiment, the communications network 30 is the standard mobile network used to connect to a standard smart phone. Because the embodiments leverage the mobile network that is already present in device 26, the installation maintenance and expense of a network manager is not required. In current systems, a network manager would be fitted in a cargo area or container of the truck and receive electrical power from an electrical power system of the truck, or from the built-in battery of the network manager. Similarly, one or more fixed network managers may be fitted in a warehouse, shipping or receiving docks, manufacturing plants, and oil rigs, for example, receiving electrical power from electrical power systems of the warehouse, or a back-up battery of the manager. In the embodiments disclosed herein, such network managers are not required.

Each device 26 is in communication with the control tower 10 via a communication network 30. The communication network 30 may be any appropriate communication network including, for example, the Internet, a virtual private network (VPN), a personal area network (PAN), a local area network (LAN), a wireless LAN (WLAN), a cellular communication network, a satellite communication network, Wi-Fi, Ethernet, USB or the like.

The sensor data 24 is transmitted to the control tower 10 via the communication network 30. Once received and compiled at the control tower, which may reside in a cloud, a user can then use a computing device to view the sensor data or a selected subset of the sensor data that is stored on the control tower 10.

The control tower 10 may be any appropriate server computer platform and its functions are to, amongst others, configure parameters and sensor threshold limits for devices 26, to receive sensor module data from tags 24 and to provide information, reports of conformity and shipping details to a user. During the transit process of an object that is associated with a tag 24, should an event be detected (such as a condition threshold being exceeded), the tag 24 can transmit an alert message to the control tower 10, or the control tower monitoring can be set to automatically trigger an alert based on the threshold preferences set by the user, after which a short messaging service (SMS) message, email or other appropriate message may be transmitted to a user. In an embodiment, both the mobile app and the control tower are configurable based on customer or user preference.

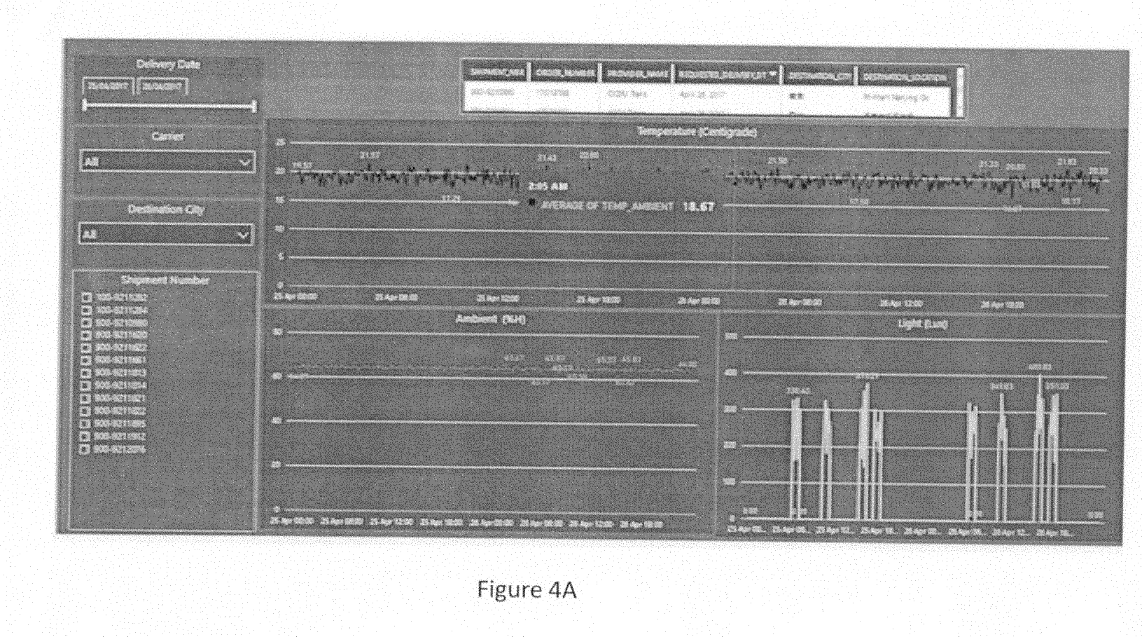

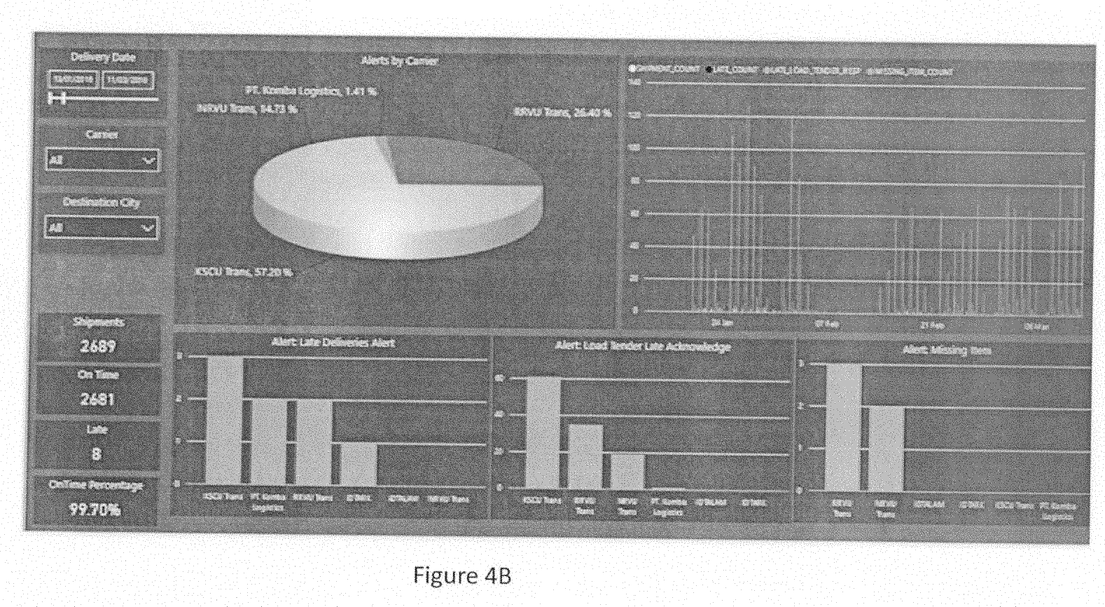

Control tower 10 is available via the custom app installed on a device associated with the driver or operator of the transport vehicle. Once connectivity is established, the app 14 can access the control tower where certain functionality and data can be stored. In an embodiment, the system is configured to associate data with a particular tag. In an embodiment, the system is configured to identify the delivery person associated with a transport vehicle and the cargo. The data can be customized as the user needs, via the app. The tracking interface and reporting system 17 is visible to any user and displays to the user a configuration of selected data, for example as in FIGS. 4A and 4B.

In one embodiment the tag 24 may be configured to only monitor all sensor data continuously or periodically. In another embodiment, the tag 24 may be configured to monitor and additionally record all sensor data continuously or periodically. In one embodiment, only the fact that the event itself was present or that it occurred is the only thing considered important or material.

An event can be any one or more of a number of environmental or physical conditions, but for the sake of this example it may include the monitored condition exceeding a threshold set for the condition, receiving an instruction from the local network manager to transmit sensor module data to the local network manager, receiving an instruction from the remotely accessible IoT platform to transmit sensor module data to the remotely accessible IoT platform or a combination or variations of these.

Utilization of resources can be a concern. Achieving a robust battery life of the tags, in particular, can be vital to the success of the system. In an attempt to extend the battery life of the monitoring device or tag 24, the user may specify how often reporting should occur (without exception alerts). For example, the user can specify that reporting should occur every minute, 30 minutes, every hour, two hours, 5 hours or the like, whereby the monitoring device or tag will then transmit the sensor data at these specified times. Even though sensor data may not be transmitted, it can, however, continue to be logged on the device independent of the interval in which data is reported. At any time during a shipment process, or once the transit of the object is completed, the user is able to access selected data for audit purposes and print or produce a certificate of conformity in accordance to the specified recording intervals. However, should the user observe any discrepancy that occurred during transit of the item, the user will be able to retrieve all the detailed sensor data on, for example, a second-by-second (or some other desired measured interval) basis from the monitoring device 24 via the control tower 10.

A user may be any user of the system 100. For example, users may include persons receiving the cargo 28, persons sending the cargo 20, persons responsible for the transport and integrity of the cargo, and persons monitoring the cargo conditions. In one embodiment, users may be able to perform various different functions and view different data according to whatever capacity they are currently working.

The system 100 described herein thus enables a tag or monitoring device 24 to associate with or join a mobile network and follow or track a cargo as they move from one location to the next, without the need to connect to multiple local networks or remote networks, network extenders and the like. The mobile communication networks 30 of the device 26 enable the monitoring devices 24 to communicate with the control tower 10 or other appropriate server computers.

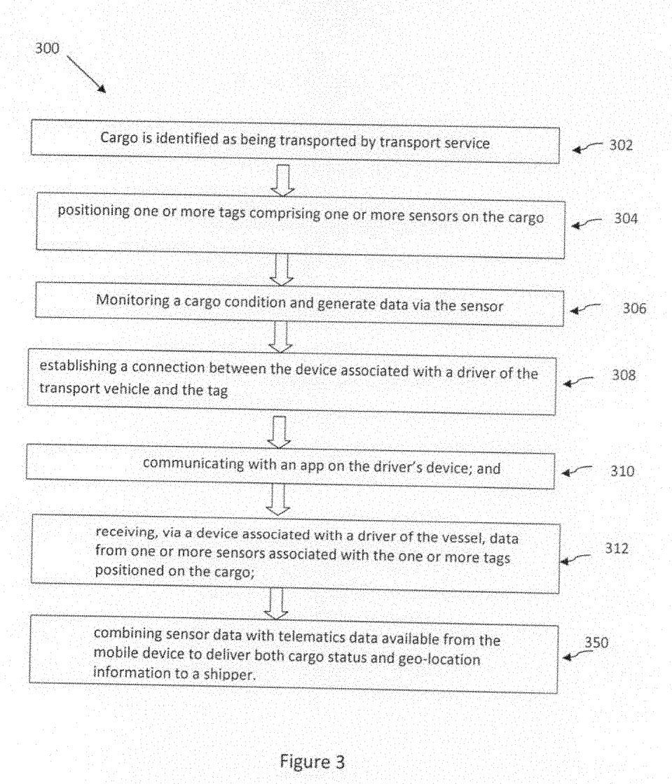

FIG. 3 is a schematic diagram which illustrates an exemplary method 300 according to one embodiment.

At FIG. 3, at an initial step 302, a cargo 22 is identified as being transported by one of any number of transport or moving services for which a device with internet capability 26 and a driver/operator 27 is associated. In some embodiments, the cargo 22 is located in a warehouse 20.

At step 304 a monitoring device, or tag 24, is placed on a discrete item of cargo being transported. In one example embodiment, tags comprising one or more sensors are affixed to the cargo to collect cargo status via the sensors.

Moving to step 306, the tag 24 monitors a condition and produces sensor data. In one embodiment, the condition is monitored by the sensor associated with the tag at pre- designated intervals. As mentioned above, the condition monitored may be rotation, acceleration, temperature, aromatic pressure, humidity, magnetic field, luminous intensity, and a measure of time amongst others. The sensor data produced may include measurement or estimates of the condition output by a sensor of the monitoring device. In some embodiments, the monitoring device may encrypt the sensor data.

At step 308, the tag is associated with the mobile device 26 via a pairing with a unique identifier transmitted by the tag to the control tower; thus, the app 14 is updated with the unique identifier from the sensor device. The control tower 10 is configured to capture the identity of the delivery driver 27. This may include the driver's name and also the driver's phone number. By updating the control tower 10 with the delivery driver phone number the system can output the cargo detail and tag unique identifier to an “app” 14 downloaded onto the delivery driver's 27 mobile phone 26.

The cargo data is maintained in a control tower 10. Cargo data includes the quantity, unit of measure and the cargo description. The control tower 10 is may also permit a warehouse user, eg 28, to associate a sensor tag 24 to the cargo data at the level preferred by the shipper. This could be at the item, carton, pallet or shipment level. Multiple tags are utilized to ensure all cargo components are associated to a sensor tag device at the level specified by the shipper.

The app on the mobile device is configured by the control tower user to seek an automated connection to the sensor device or in another embodiment, the driver may manually input the MAC code printed on the sensor device to establish the connection. The app may use a standard mobile device sensing protocols such as Wifi, Wimax, IR, NFC, Bluetooth and ZigBee, or any other standard mobile connectivity protocol, for example, (Bluetooth, NFC, S-Beam etc.) to complete the connection to the sensor device. The control tower function may include an identification of the delivery driver and his specific mobile phone thereby the system can now update the cargo tag identifier to the application app downloaded onto the driver's phone.

The control tower 10 may be equipped with optional alert logic. Alerts will be automatically triggered to users (warehouse, driver, shipper) if the sensor device affixed to the cargo does not connect to the delivery drivers phone as expected.

In such an embodiment, the system detects problems with a connection from a sensor device to driver phone which may fail. The system can detect if a sensor becomes disconnected from the mobile app for any reason. As the system and method for collecting data from the cargo and the phone is dependent on this data connection the alert process serves as a failsafe to ensure this connection is completed before the delivery commences.

Moving to step 312, the device 26 receives data from the one or more sensors. The control tower 10 and system may include cargo tracking data. The data collected includes sensor data as collected by the sensor device affixed to the cargo and also the telematics collected from the delivery driver's mobile phone.

The method concludes at step 350 when the tag device connects to the driver's phone and, once connected, the app on the driver's phone will collect data from the tag sensors and combine this with telematics from the mobile phone including the GPS position of the delivery driver. Together the sensor data from the tag device and the telematics from the mobile phone GPS system is the cargo status data that informs the shipper as to the state condition and location of cargo during the delivery process.

The control tower system may provide a new tracking and status interface for the shipper 28. The shipper may see the cargo status data (as reported by the sensor device) and also the geo-location data as provided from the delivery driver's mobile phone and downloaded app.

The cargo data is updated via the mobile app to the system through existing mobile networks and is thereby available to the shipper on demand or as needed.

FIGS. 4A and 4B show example embodiments of screenshots showing how a control tower system 10 can be extended to allow for delivery driver assignment to a specific shipment. The delivery driver is registered in the system including his name and also his mobile phone number. By maintaining the delivery driver's mobile phone number the system can update data to the downloaded mobile app including the tag device unique identifier and delivery driver assignment to specific shipments thru a simple interface. Through aggregating and performing statistical analysis on the data, the system can also display information about temperature, number of alerts, locations, average light readings, missing cargo and information about the carrier itself, for example, data regarding damaging, late or missing deliveries. The system can also display information related to the carrier such as number of trips, and the like.

In system 100, data may be stored in a cloud based data warehouse. This is the control tower 10. In one embodiment, the customer may review data in real-time, run reports, or perform other data manipulation or statistics. The drivers download the specialized app 14 enabling teal-time tracking and monitoring of goods during transport.

Geolocation is the identification or estimation of the real-world geographic location of an object, such as a radar source, mobile phone, or Internet-connected computer terminal. In its simplest form geolocation involves the generation of a set of geographic coordinates and is closely related to the use of positioning systems, but its usefulness is enhanced by the use of these coordinates to determine a meaningful location, such as a street address. In one embodiment, location is achieved using GSM which is the triangulation of mobile connectivity to cell phone towers.

The mobile app 14 connects to a low cost sensor 24 which is affixed to the cargo goods. Real time monitoring from the sensor is updated via the mobile app to the user's control panel or device, wherever the user is located. In one embodiment, the sensor detects any change in light and so the user will be alerted if the doors of the truck are opened outside of the origin or destination geo-fence.

By way of example, the tag sensor device can be associated to the cargo at any level. Cargo can be associated with a tag at the item level, the carton level, the pallet level or the container level. The unit of measure of the cargo is known by the system and the level of association is a setting that can be adjusted based on the preferences of the shipper. Alternatively, the sensor and tag can be applied to a specific vehicle, eg a truck. Adding a sensor tag to the inside cargo hold of the truck will be useful especially for shippers who own their own fleet or are leasing a truck.

The system can integrate with any tag device. In one example embodiment, the Tag device includes sensors that collect data that is meaningful to the state and condition of the cargo. For example, if frozen or refrigerated cargo is being transported, then the tag should include a temperature sensor. The sensor array available to the system can include (but is not limited to): temperature, humidity, acceleration, light, sound, magnetism and radiation.

In an embodiment, a tag has one sensor. The tag includes the sensor array, the power source (battery) and a communication function (like BlueTooth or Zigbee). In another embodiment, two sensors can be housed together, for example, on the same tag. For example, a user might detect temperature and humidity and light if you are monitoring the transport of lottery tickets which are sensitive to temp and humidity and also a security problem.

In one example embodiment, the mobile phone and app work automatically to seek a connection with the tag device. The delivery driver does not need to do anything to facilitate the connection or maintain the connection between mobile phone and tag. In one embodiment, to extend the utility of the tracking function, a purpose-built computer can be deployed to collect data from tags/sensors while they are waiting pickup or after delivery. The computer is called a sensor hub. The sensor hub is a custom made computer that is purpose built to connect via blue tooth to the sensor tags and transmit the sensor data to the cargo tracking database via a normal WiFi data connection.

Therefore in an embodiment of an example deployment, a customer could install a sensor hub at the pickup and delivery locations and the delivery driver would install a sensor active mobile app. In this scenario, the data from the sensor tag is collected without interruption from pre-pickup, during transit and then after delivery.

In yet another example embodiment, a delivery driver may actively interact with the device to confirm the tag and sensors are connected and working as intended.

By way of example, the system (or mobile app) works to automatically seek connection with the tag device and triggers an alert if an expected tag device is not detected. The mobile app would require additional input to know that a tag should have been detected. The driver would be expected to signal that the cargo “pickup” is completed. If the pickup signal is received and an expected Tag connection has not been achieved, then the alert triggers prompting the driver to actively work to connect the app to the Tag device.

In one embodiment, the use of the light (or luxometer) is especially useful to secure the cargo. When a sensor is inside the cargo hold of the truck the lux reading is zero. If the doors of the truck are opened, then the lux reading immediately jumps. Shippers who are transporting high value goods would be notified in real time if the doors of the truck are opened while the truck is outside of the designated pickup or delivery locations. Because the luxometer on the sensor is measuring small changes in light, this security method effectively alerts the user even if the doors are opened at night.

It is possible for the shipper to utilize a Tag device that does not have any sensors. In one example embodiment, the association of Tag device to delivery driver mobile App will only serve to assure the shipper that his “tagged” cargo is in fact being delivered. Further, the shipper will benefit from the geo-location information that is collected from the driver mobile phone.

In one embodiment, the sensors are re-usable and usually run on a replaceable coin-cell battery. In an embodiment, the sensor is connected to the mobile app on a driver's cell phone and there is no need for a monthly data plan. Therefore, after an initial investment there is no recurring cost for sensors.

The growth of demand for Internet of Things (IoT) ensures that sensor capability will improve while the cost for new sensors will remain low. Sensors may be customized to match a user's unique supply chain requirements, e.g. The right sensor is chosen for a user's specific goods.

The mobile app sends a location ping at regular intervals allowing logistics tracking in in real time. Pickup and Delivery events are controlled using a geo-fence. For example, in a pick up or delivery example, because the sensor detects any change in light a user will be alerted if the doors of the truck are opened outside of the origin or destination geo-fence.

### EXAMPLES

In one example, Company A is a supplier of frozen seafood to restaurants. When it is hot during the summer, Company A is worried that the fish will defrost during transit and create a problem for their brand. In carrying out the solution according to the methods and systems above, sensors, for example, IoT sensors, are employed in Company A's delivery van cargo areas and collected location and temperature data during delivery to ensure freshness, no spoliation, and timely delivery.

In another example, Company B is a supplier of glass to mobile phone manufacturers. If the truck driver deviates from the prescribed route or is not careful to avoid rough places on the road or if the transport vehicle is not equipped with sufficient shock absorbers then the glass delivered to the factory arrives with cracks which creates a problem for the brand. In carrying out the solution according to the methods and systems above, a sensor, e.g. an IoT sensor, is deployed on the trucks for Company B and the geo-location and shock motion during transport is carefully monitored ensuring the glass is delivered with no cracks.

In one example, Company C is a supplier of cigarettes. The truck carrying cartons of cigarettes can be opened by thieves during transport and the stolen goods are mixed with lower quality products and sold on the black market creating a problem for the brand. To counter Company C employs security guards to sit with the driver in the cab of the truck. However, the guard cannot always see if the back of the truck has become opened. In carrying out the solution according to the methods and systems above, a sensor, e.g. an IoT sensor, is deploy on the trucks for Company C and light in the truck is carefully monitored ensuring the door to the truck is closed at all times during transport. If the sensor detects light, then the Security Guard is immediately notified.

The disclosures of each patent, patent application and publication cited or described in this document are hereby incorporated herein by reference, in their entirety.

While the foregoing specification has been described with regard to certain preferred embodiments, and many details have been set forth for the purpose of illustration, it will be apparent to those skilled in the art without departing from the spirit and scope of the invention, that the invention may be subject to various medications and additional embodiments and that certain of the details described herein can be varied considerably without departing from the basic principles of the invention. Such modifications and additional embodiments are also intended to fall within the scope of the appended claims.

### CONCLUSION

A number of embodiments of the present disclosure have been described. While this specification contains many specific implementation details, there should not be construed as limitations on the scope of any disclosures or of what may be claimed, but rather as descriptions of features specific to particular embodiments of the present disclosure. References made to literature such as Wikipedia, are believed to be referenced from content present as of the date of filing.

Certain features that are described in this specification in the context of separate embodiments can also be implemented in combination in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying Figures do not necessarily require the particular order show, or sequential order, to achieve desirable results. In certain implementations, multitasking and parallel processing may be advantageous. Nevertheless, it will be understood that various modifications may be made without departing from the spirit and scope of the claimed disclosure.

What is claimed is:

1. A system for assessing cargo conditions, said cargo occupying a cargo area on a transport vehicle, said system comprising:
at least one tag device wherein each tag device comprises at least one sensor operative to determine at least one data point indicative of conditions of the cargo;
a device associated with a driver of the vessel, the device having access to a communications network; and
an app installed on the device configured to determine a geo-location of the device;
wherein a mobile function is integrated into the device associated with the driver and not integrated into the at least one tag,
wherein the at least one data point is available in real time;
wherein the geo-location is available in real time;
wherein the data from the at least one sensor retrieved by the device is combined with the geo-location data available on the device to provide a shipper with real time status of the cargo and exact geo-location during transit from a source to a destination; and
wherein the data is stored in a location that is not in the device.

2. The system of claim 1, wherein the at least one tag has connectivity with the device via a bluetooth connection.

3. The system of claim 1, wherein at the least one sensor associated with the at least one tag is collecting and transmitting data associated with an air temperature of the inside of the vessel.

4. The system of claim 1 wherein the at least one sensor associated with the at least one tag is collecting and transmitting data associated with a temperature of the cargo itself, inside of the vessel.

5. The system of claim 1, wherein the at least one sensor associated with the at least one tag is collecting and transmitting data associated with an indication of stability of the cargo.

6. The system of claim 1 wherein the at least one sensor associated with the at least one tag is collecting and transmitting data associated with an indication of light conditions inside the cargo area of the vessel.

7. The system of claim 1, wherein at the least one sensor associated with the at least one tag is collecting and transmitting data associated with an indication of a humidity level of the cargo area associated with the vessel.

8. A method for assessing cargo conditions, said cargo being located on a transport vehicle, said method comprising:
positioning a tag comprising a sensor on or near the cargo;
establishing a connection between a device associated with a driver of the transport vehicle and the tag;
communicating with a control tower via an app on the device associated with the driver; and
receiving, in the device associated with the driver, data from sensor associated with the tag positioned on the cargo;
receiving, in the device, telematic data from the mobile device;
combining sensor data with telematics data; and
delivering cargo conditions data and telematic information to a shipper.

9. The method of claim 8, wherein the establishing a connection comprises the sensor transmitting a unique identification code together with status from the sensor.

10. The method of claim 8, further comprising connecting with the device to actively seek a connection with the tag device using a mobile device sensing protocol.

11. The method of claim 8, further comprising connecting the tag to the driver device wherein the app on the device is configured to receive data from the tag sensors and combine this data with telematics from the mobile phone including the GPS position of the delivery driver.

12. The data of claim 11, wherein the sensor data from the tag device and telematics data from the mobile phone GPS system is the cargo status that informs the shipper as to the state condition and location of cargo during the delivery process.

13. The data of claim 12 wherein the data is updated via the mobile app to the system through existing mobile networks and is thereby available to the shipper on demand.

14. The method of claim 8, wherein the telematic data comprises geo-location data.
